(19) United States
(12) Patent Application Publication
(10) Pub. No.: US 2017/0116696 A1
(43) Pub. Date: Apr. 27, 2017

(54) RIDESHARE DISPATCH SYSTEM

(71) Applicant: Mitchell Moore, Ormond Beach, FL (US)

(72) Inventor: Mitchell Moore, Ormond Beach, FL (US)

(21) Appl. No.: 15/332,366

(22) Filed: Oct. 24, 2016

Related U.S. Application Data
(60) Provisional application No. 62/246,874, filed on Oct. 27, 2015.

(51) Int. Cl. G06Q 50/30; G06Q 30/04; G06F 3/0482; G06Q 40/08

(52) U.S. Cl. CPC G06Q 50/30; G06Q 40/08; G06Q 30/04; G06F 3/0482

(57) ABSTRACT

A dispatch system may include a driver scale, and acceptable driver fee, and passenger indicia. The driver scale may be displayed on a driver graphical interface. An acceptable driver fee associated with a portion of the driver scale may be selectable by a driver and displayed on the driver graphical interface. Passenger indicia may be displayed on the driver graphical interface dependent on the value of the selected acceptable driver fee.

### RELATED APPLICATIONS

This application claims the benefit under 35 U.S.C. §119(e) of U.S. Provisional Patent Application Ser. No. 62/246,874 filed on Oct. 27, 2015 and titled Rideshare Dispatch System and Associated Methods, the entire content of which is incorporated herein by reference.

### FIELD OF THE INVENTION

The present invention relates to systems for coordinating dispatch of vehicles for hire. More specifically the system relates to systems for allowing passengers and drivers of vehicles for hire to contract directly with one another.

### BACKGROUND OF THE INVENTION

This invention relates generally to the field of transportation services. More particularly, the invention relates to an improved system for providing transportation services over a data communications network.

The automobile is one of the most successful inventions of all time but automobiles and the industry surrounding them are also responsible for more pollution and toxic waste than any other product of the industrial era. Unfortunately, the typical use of automobiles is extremely inefficient. On a typical day, one can see large numbers of personal automobiles parked and not in use. This represents a large base of underutilized capital goods. At the same time, the use of alternative modes of transportation that are more efficient, including, public transportation, taxis, and private cars, is either inconvenient or too expensive. Private automobiles are both ubiquitous and inefficiently utilized, in part because the modern consumer wants the “on demand” transportation services a waiting car represents. In a typical rush hour commute virtually every car is driven by a sole driver. A more convenient and efficient utilization of automobiles and other forms of on-demand transportation could replace a large number of automobiles and therefore be a boon to consumers, the environment, and congestion on our highways. If applied to other on-demand resource situations, it could also be used to enhance the efficiency of industry and commerce.

### SUMMARY OF THE INVENTION

With the above in mind, embodiments of the present invention are related to a dispatch system including a driver scale, an acceptable driver fee, and passenger indicia. The driver scale may be displayed on a driver graphical interface. An acceptable driver fee may be associated with a portion of the driver scale, selectable by a driver, and displayed on the driver graphical interface. Passenger indicia displayed on the driver graphical interface may be dependent on the value of the selected acceptable driver fee.

The dispatch system may include a passenger scale, an acceptable passenger fee, and driver indicia. The passenger scale may be displayed on a passenger graphical interface. The acceptable passenger fee may be associated with a portion of the passenger scale, selectable by a passenger, and displayed on the passenger graphical interface. Driver indicia may be displayed on the passenger graphical interface dependent on the value of the selected acceptable passenger fee and the selected acceptable driver fee.

The display of the passenger indicia may be further dependent on the value of the selected acceptable passenger fee.

The dispatch system may include a map. Each of the passenger indicia may be associated with a respective passenger. The passenger indicia may be displayed at locations on the map corresponding to geographic locations of the respective passengers associated with each of the passenger indicia.

Each of the driver indicia may be associated with a respective driver. The driver indicia may be displayed at locations on the map corresponding to geographic locations of the respective drivers associated with each of the driver indicia.

The display of passenger indicia on the driver graphical interface may be further dependent on the value of prioritization criteria. The passenger indicia may be selectable by the driver. Each of the passenger indicia may be associated with a respective passenger. A message may be sent to the associated respective passenger upon selection of the passenger indicia.

The dispatch system may include a graphical display module and a fee module. The graphical display module may be adapted to provide a graphical interface to a user. The fee module may include a driver scale module and a passenger scale module. The driver scale module may be adapted to provide a driver scale to the graphical display module. The passenger scale module may be adapted to provide a passenger scale to the graphical display module. The driver scale or passenger scale may be displayed on the graphical interface. The fee module may calculate an administrative fee as the difference between the acceptable passenger fee selected from the passenger scale by the passenger and the acceptable driver fee selected from the driver scale by a driver.

The dispatch system may include a user role determination module adapted to provide a user role to the fee module.

The graphical display module may include a map module adapted to display a map on the graphical interface with the passenger indicia displayed at locations corresponding to the geographical locations of passengers associated with respective passenger indicia. The graphical display module may further include a map module adapted to display a map on the graphical interface with the driver indicia displayed at locations corresponding to the geographical locations of drivers associated with respective driver indicia.

The dispatch system may include a priority module adapted to manipulate the appearance of the passenger indicia dependent on the value of prioritization criteria.

The dispatch system may include a priority module adapted to manipulate the appearance of the driver indicia dependent on the value of prioritization criteria.

The dispatch system may include a selection module adapted to receive input from a driver indicating the passenger indicia selected by the driver.

The dispatch system may include a notice module adapted to provide a message to the passenger associated with the selected passenger indicia.

The dispatch system may include a selection module adapted to receive input from a passenger indicating the driver indicia selected by the passenger.

The dispatch system may include a notice module adapted to provide a message to the driver associated with the selected driver indicia.

The dispatch system may include an insurance verification module, which may include a passenger insurance verification module and a driver insurance verification module. The passenger insurance verification module may be adapted to provide passenger insurance coverage information to the graphical display module. The driver insurance verification module may be adapted to provide driver insurance coverage information to the graphical display module.

### BRIEF DESCRIPTION OF THE DRAWINGS

FIG. 1 is a diagram of a graphical interface according to one embodiment of the inventive system.

FIG. 2 is a flowchart depicting a method for matching a driver with a passenger according to an embodiment of the present invention.

FIG. 3 is another flowchart depicting a method for matching a driver with a passenger according to an embodiment of the present invention.

FIG. 4 is another flowchart depicting a method for matching a driver with a passenger according to an embodiment of the present invention.

FIG. 5 is another flowchart depicting a method for matching a driver with a passenger according to an embodiment of the present invention.

FIG. 6 is a block diagram of the dispatch system according to one embodiment of the inventive system.

FIG. 7 is a diagram of a passenger graphical interface according to one embodiment of the inventive system.

FIG. 8 is a diagram of a driver graphical interface according to one embodiment of the inventive system.

FIG. 9 is a diagram of a graphical interface according to one embodiment of the inventive system.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system and associated method for matching vehicles-for-hire with passengers. The dispatch system 36 may allow a vehicle-for-hire driver 37 to indicate the cost at which the driver 37 may provide services to a passenger 38. The dispatch system 36 may allow a passenger 38 to indicate the price the passenger 38 is willing to pay for the driver's 37 services. The dispatch system 36 may match drivers 37 with passengers 38 based on fee information. The dispatch system 36 may provide the passenger 38 verification that the passenger is protected by insurance while utilizing the driver's services. The dispatch system 36 may provide verification that the vehicle is protected by insurance.

The dispatch system 36 and associated methods may allow a passenger 38 to be paired with a for hire driver 37. The passenger 38 and driver 37 may be paired based on multiple factors. By way of example, and not as a limitation, the location of the passenger, the location of the driver, the fee the passenger 38 is willing to pay, and the fee the driver 37 is willing to accept, or the like may be considered when pairing a passenger 38 and a driver 37.

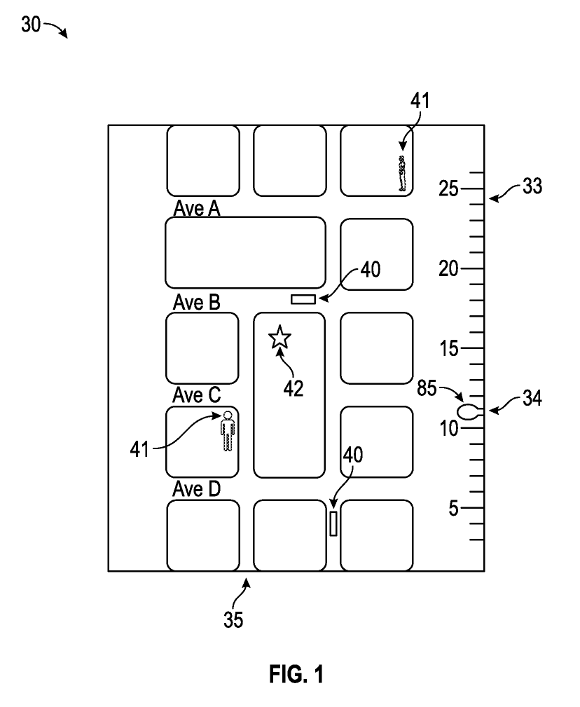

The dispatch system 36 may utilize a graphical display module 39 to provide a visual representation of the location of drivers 37 and passengers 38. FIG. 1 depicts a possible embodiment of a graphical interface 30 including a visual representation that may provide the passenger 38 with information related to the driver 37 or the vehicle driven by the driver 37. The graphical interface 30 may display driver indicia 40. By way of example, and not as a limitation, the driver indicia 40 may indicate the color, year, model, or make of the vehicle. The driver indicia 40 may indicate whether or not smoking, eating, drinking, or the like is allowed inside the vehicle. The driver indicia 40 may include a rating for the driver 37. The displayed driver rating may be determined from comments or reviews left by previous passengers 38. The driver indicia 40 may be presented on the graphical interface 30 at a corresponding location on a map 35 representative of the geographic location of the driver 37 associated with a respective driver indicium 40.

The graphical interface 30 may provide the driver 37 with information related to the passenger 38. The graphical interface 30 may display passenger indicia 41. By way of example, and not as a limitation, the passenger indicia 41 may indicate the length of the passenger's anticipated travel, frequency of the passenger's use of the dispatch system 36, or the like. The passenger indicia 41 may indicate whether or not the passenger 38 desires to engage in smoking, eating, drinking, or the like while inside the vehicle. The passenger indicia 41 may include a rating for the passenger 38. The displayed passenger rating may be determined from comments or reviews left by previous drivers 37. The passenger indicia 41 may be presented on the graphical interface 30 at a corresponding location on a map 35 representative of the geographic location of the passenger 38 associated with a respective passenger indicium 41.

A user indicia 42 may be presented on the graphical interface 30 at a corresponding location on the map 35 representative of the geographic location of the user utilizing the graphical interface 30. The location of the indicia 40, 41, 42 on the map 35 may be updated as the respective driver 37, passenger 38, or user changes their geographic locations in real life and/or real time.

The dispatch system may utilize a fee module 43 to determine the amount of fees to be charged. The fee module 43 may have a driver scale module 44 and a passenger scale module 45. The driver scale module 44 may allow the driver to determine an acceptable driver fee 32. The passenger scale module 45 may allow the passenger to determine acceptable passenger fee 34. As will be discussed in greater detail below, those skilled in the art will appreciate that the acceptable driver fee 32 may also include a fee that the driver is willing to accept, or a range of fees that the driver is willing to accept. Similarly, those skilled in the art will appreciate that the acceptable passenger seat 34 may also include a fee that the passenger is willing to pay for driver services or a range of fees that the passenger is willing to pay. Those skilled in the art will still further appreciate that in a situation where the driver submits a range of fees as the acceptable driver fee 32, the range is not visible to prospective passengers. Similarly, in a situation where the passenger submits a range of fees as the acceptable passenger fee 34, the range is not visible to prospective drivers.

The acceptable driver fee 32 may indicate the cost the driver 37 will charge for providing transportation. The driver 37 may indicate a minimum cost. The driver 37 may indicate a maximum cost. The cost indicated by the driver 37 may be the cost that will be incurred by the passenger 38. The cost indicated by the driver 37 may be the amount recovered by the driver 37 after payment of fees to third parties. The indicated cost may be for the entire transportation of the passenger 38, for a unit of distance travelled, for a unit of time the passenger 38 utilizes the vehicle, or for any combination of these. The passenger 38 may accept a cost indicated by the driver 37. It is also contemplated that the cost may include any applicable tolls.

The passenger 38 may indicate a price the passenger 38 is willing to pay for transportation. The passenger 38 may indicate a minimum price. The passenger 38 may indicate a maximum price. The price indicated by the passenger 38 may be the price that will be paid by the passenger 38. The price indicated by the passenger 38 may be the price paid in addition to additional fees paid to a third party. The indicated price may be for the entire transportation of the passenger 38, for a unit of distance travelled, for a unit of time the passenger utilized the vehicle, or for any combination of these. The driver 37 may accept a price indicated by the passenger 38. Similar to the above, the price indicated by the passenger may include the price of tolls, or, alternatively, may indicate that the tolls are expected to be included in the price.

Utilizing the graphical interface 30, a vehicle-for-hire driver 37 may indicate the fee for the driver's 37 services. This may be done by utilizing a driver scale 31, which may be controlled by the driver scale module 44. As depicted, the driver scale 31 may be on a side of the graphical interface 30. However, those skilled in the art will appreciate that the driver scale 31 may be located in different orientations and implemented in various ways. By way of example, and not as a limitation, the driver scale 31 may be located on the left, right, top, or bottom of the graphical interface 30. Again, by way of example, and not as a limitation, the driver scale 31 may be a slider, a radio button, a dial, text input box, other means for selecting an acceptable price, or the like. The driver 37 may select a minimum fee the driver 37 will accept from a passenger 38. The driver 37 may select range of fees the driver is willing to accept from a passenger 38. The fee the driver 37 is willing to accept may be the acceptable driver fee 32. The acceptable driver fee 32 may be displayed or indicated on the graphical interface 30. The acceptable driver fee 32 may be highlighted, in bold, underlined, or otherwise differentiated from other fee values indicated on the driver scale 31. The acceptable driver fee 32 may be marked with indicia.

The driver scale 31 may be configured to allow a driver 37 to scroll through acceptable driver fees 32. In such a configuration, the driver scale 31 may be adapted to allow a driver 37 to incrementally increase or decrease the acceptable driver fee 32. The incremental increasing or decreasing may be accomplished by adjusting a graphical representation of a driver fee marker 84 corresponding to the acceptable driver fee 32. As the driver fee marker 84 is scrolled up or down along the driver scale 31, passengers 38 who are willing to pay the driver fee 32 associated with the position of the driver fee marker 84 are displayed to the driver 37. A driver 37 may scroll to a higher driver fee 32 and the graphical interface 30 may present all passengers 38 willing to pay only the higher driver fee 32. Scrolling to a lower driver fee 32 may present additional passengers 38 to the driver 37, who are only willing to pay the lower driver fee 32.

Utilizing the graphical interface 30, a passenger 38 may indicate the desired fee for driver services. This may be done by utilizing a passenger scale 33, which may be controlled by a passenger scale module 45. As depicted, the passenger scale 33 may be on a side of the graphical interface 30. However, those skilled in the art will appreciate that the passenger scale 33 may be located in different orientations and implemented in various ways. By way of example, and not as a limitation, the passenger scale 33 may be located on the left, right, top, or bottom of the graphical interface 30. Again, by way of example, and not as a limitation, the passenger scale 33 may be a slider, a radio button, a dial, input box, other means for selecting an acceptable price, or the like. The passenger 38 may select a maximum fee the passenger 38 will pay to a driver 37. The passenger 38 may select a range of fees the passenger 38 is willing to pay to a driver 37. The fee the passenger 38 is willing to pay may be the acceptable passenger fee 34. The acceptable passenger fee 34 may be displayed or indicated on the graphical interface 30. The acceptable passenger fee 34 may be highlighted, in bold, underlined, or otherwise differentiated from other fee values indicated on the passenger scale 33. The acceptable passenger fee 34 may be marked with indicia.

The passenger scale 33 may be configured to allow a passenger 38 to scroll through acceptable passenger fees 34. In such a configuration, the passenger scale 33 may be adapted to allow a passenger 38 to incrementally increase or decrease the acceptable passenger fee 34. The incremental increasing or decreasing may be accomplished by adjusting a graphical representation of a passenger fee marker 85 corresponding to the acceptable passenger fee 34. As the passenger fee marker 85 is scrolled up or down along the passenger scale 33, drivers 37 who are willing to accept the passenger fee 34 associated with the position of the passenger fee marker 85 are displayed to the passenger 38. A passenger 38 may scroll to a lower passenger fee 34 and the graphical interface 30 may present all drivers 37 willing to accept only the lower passenger fee 34. Scrolling to a higher passenger fee 34 may present additional drivers 37 to the passenger 38, who are only willing to accept the higher passenger fee 34.

The driver scale 31 and the passenger scale 33 may allow the driver 37 and passenger 38 to interface with the fee module 43 and select currently available acceptable fees or fee ranges. The currently available acceptable fees may change. The currently available acceptable fees may change dynamically based upon factors relating to the availability of drivers or passengers. The driver scale 31 or passenger scale 33 may present different available acceptable fee ranges during certain events. During peak traffic hours, commuting hours, special events, inclement weather, or the like, the acceptable fee ranges may be increased. At times when the system detects a lower than average supply of passengers, or a larger than average supply of drivers, the acceptable fee ranges may be reduced. The driver or the passenger may have the ability to select an acceptable fee outside of that suggested by the system.

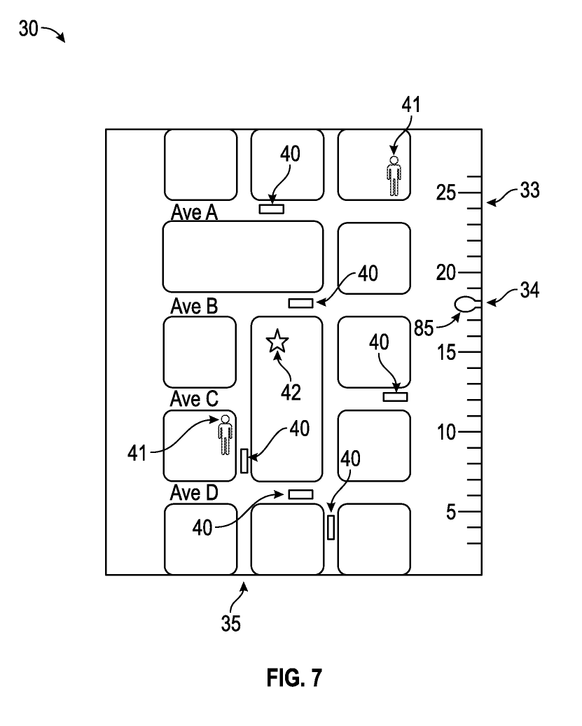

The graphical interface 30 utilized by the passenger 38 may differ from the graphical interface 30 utilized by the driver 37. FIGS. 1 and 7 depict an embodiment of the graphical interface 30 that may be utilized by a passenger 38. The user's location may be indicated on the map 35 with a user indicium 42. The passenger scale 33 may provide different options for acceptable passenger fees 34. The passenger 38 may select the acceptable passenger fee 34 the passenger 38 is willing to pay. The graphical interface 30 may display only the drivers 37 who have agreed to accept a passenger fee as low as that selected by the passenger. As depicted in FIGS. 1 and 7, as the passenger 38 selects a higher acceptable passenger fee 34, more driver 37 options may be displayed to the passenger 38.

The graphical interface 30 may display to the user information related to other passengers 38. This information may be presented to the user as passenger indicia 41. The user may provide parameters to the graphical interface 30 and the graphical interface 30 may display passenger indicia 41 related only to other passengers 38 who meet the criteria. The graphical interface 30 may display passenger indicia 41 for all passengers 38 utilizing the dispatch system 36. The passenger indicia 41 may include information related to the desired destination of other passengers 38. The graphical interface 30 may facilitate ride sharing between passengers 38 headed to proximate destinations.

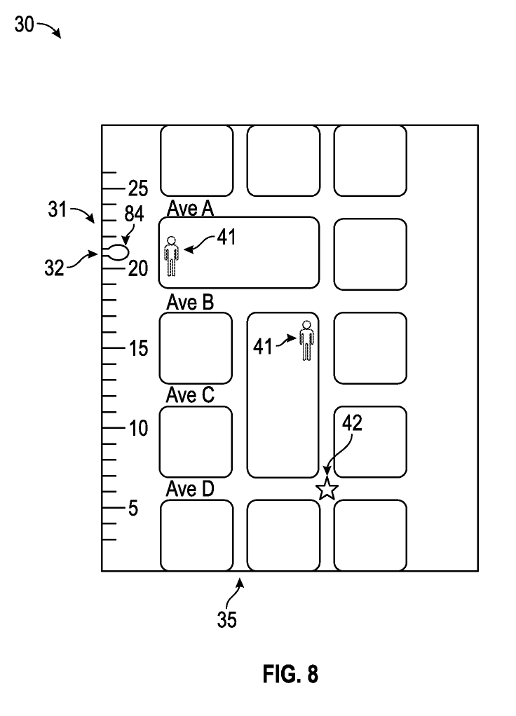

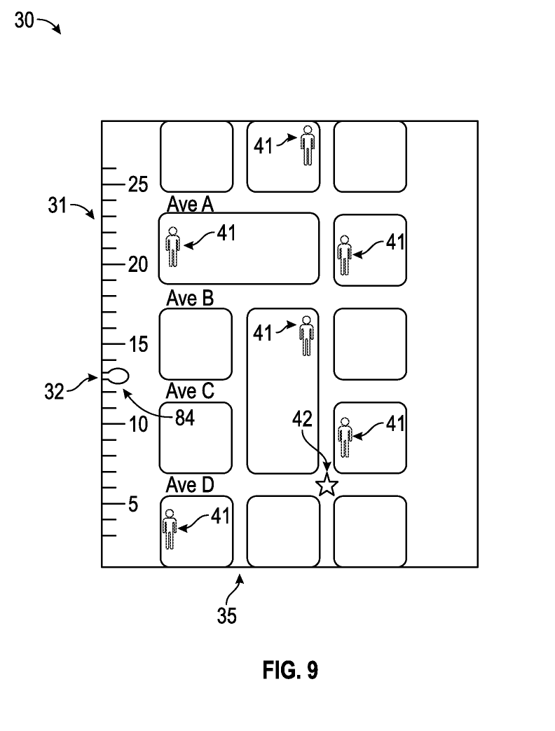

FIGS. 8 and 9 depict an embodiment of the graphical interface 30 that may be utilized by a driver 37. The user's location may be indicated on the map 35 with a user indicium 42. The driver scale 31 may provide different options for acceptable driver fees 32. The driver 37 may select the acceptable driver fee 34 the driver 37 is willing to receive. The graphical interface 30 may display only the passengers 38 who have agreed to pay a driver fee as high as that selected by the driver. As depicted in FIGS. 8 and 9, as the driver 37 selects a lower acceptable driver fee 32, more passenger 38 options may be displayed to the driver 37.

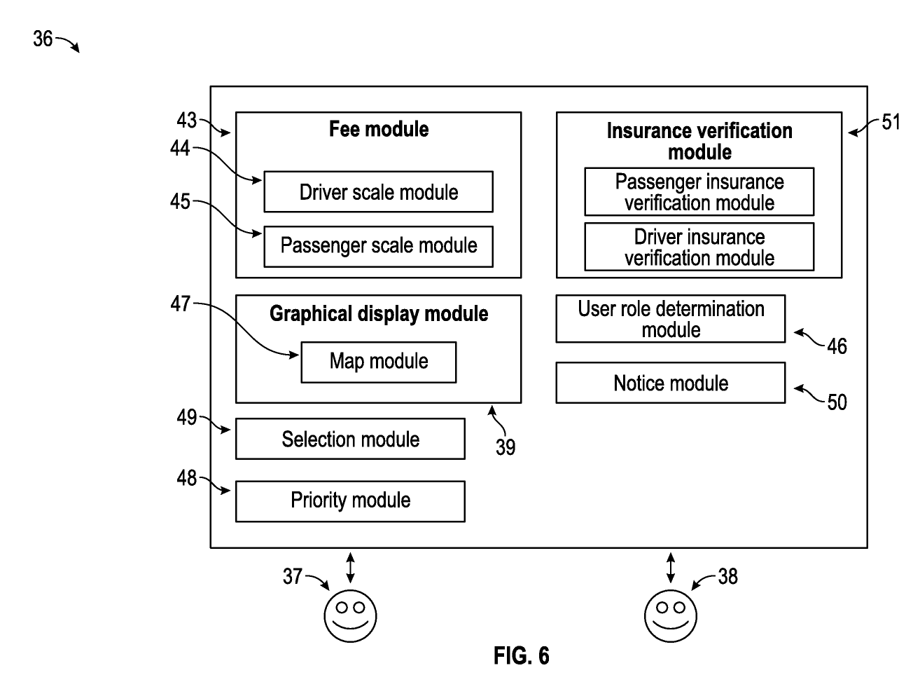

Turning to FIG. 6, the dispatch system 36 may have a user role determination module 46 that may determine if a user is a driver 37. This determination may be made by requesting input from the user to indicate the user's role as a driver 37. This determination may be made by the driver's 37 use of an application designed to be used only by a driver 37. A driver 37 may have to enter, or otherwise provide, an access code, confirmation, or the like, indicating that the user is a driver. Upon confirmation by the user role determination module 46 that the user is a driver 37, the graphical display module 39 may utilize a map module 47 to present the user with a map 35 and a driver scale 31. The driver may utilize the driver scale 31 to indicate an acceptable driver fee 32.

The graphical interface 30 may display passenger indicia 41 to present potential passengers to the driver. The potential passengers may be shown on a map 35. The potential passengers may be represented on the map 35 as passenger indicia 41 corresponding to their current geographic location. The potential passengers' intended destination may be presented to the driver 37. The potential passengers presented to the driver 37 may be any passenger 38 using the system. In one embodiment, only potential passengers who have agreed to an acceptable passenger fee 34 at least as high as the acceptable driver fee 32 selected by the driver, may be displayed as passenger indicia 41. In one embodiment, all potential passengers may be displayed as passenger indicia 41 and potential passengers who have agreed to an acceptable passenger fee 34 at least as high as the acceptable driver fee 32 selected by the driver may be identified. This identification may occur by altering the appearance of the potential passengers on the map 35.

The dispatch system 36 may have a priority module 48 that reviews criteria of potential passengers and may present the potential passengers to the driver 37 in a prioritized manner. Presenting potential passengers in a prioritized manner may mean that any particular passenger 38 may be ranked, tiered, or the like. The driver 37 may be able to sort the potential passengers based on criteria, including, but not limited to, acceptable passenger fee, current proximity to driver, proximity to passenger's intended destination, or the like.

The dispatch system 36 may have a selection module 49, which the driver 37 may utilize to select a potential passenger 38. Once a potential passenger 38 is selected, the system may provide a message to the potential passenger 38 that the driver 37, who selected the potential passenger 38, will be providing services to the passenger 38. The message may include information related to the driver or the driver's 37 vehicle. Such information may include, but is not limited to, vehicle make, model, color, driver's 37 name, driver's 37 physical appearance, or the like. The dispatch system 36 may provide additional information to the driver 37 about a potential passenger 38 after the driver 37 has selected the potential passenger 38. The additional information may include, but is not limited to, information related to the passenger's 38 location, passenger's 38 name, passenger's 38 physical appearance, or the like. The passenger 38 and the driver 37 may have an opportunity to confirm or verify that they will provide and receive services from each other. The dispatch system may utilize the fee module 43 to provide the passenger 38 and driver 37 with information related to the costs of the driver's 37 services.

The dispatch system 36 may utilize the user role determination module 46 to determine if a user is a passenger 38. This determination may be made by requesting input from the user to indicate the user's role as a passenger 38. This determination may be made by the passenger's 38 use of an application designed to be used only by a passenger 38. Upon confirmation that the user is a passenger 38, the graphical display module 39 may utilize the map module 47 to present the user with a map 35 and a passenger scale 33. The passenger 38 may utilize the passenger scale 33 to indicate an acceptable passenger fee 34.

The graphical display module 39 may display driver indicia 40 to present available drivers to the passenger 38. The available drivers 37 may be shown on a map 35. The driver indicia 40 corresponding to available drivers 37 may appear on the map 35 at their respective current geographic locations. The available drivers' 37 acceptable driver fees 32 may be presented to the passenger 38. The available drivers 37 presented to the passenger 38 may be any driver 37 using the system. The available drivers 37 presented to the passenger 38 may only be available drivers 37 you have agreed to an acceptable driver fee 32 at least as low as the acceptable passenger fee 34 selected by the passenger 38. In embodiments in which drivers other than those who have agreed to the acceptable passenger fee 34 selected by the passenger are displayed to the passenger, available drivers 37 who have agreed to an acceptable driver fee 32 at least as low as the acceptable passenger fee 34 selected by the passenger, may be identified by the graphical interface 30. This identification may occur by altering the appearance of the available drivers 37 on the map 35.

The dispatch system 36 may utilize the priority module 48 to present available drivers 37 to the passenger 38 in a prioritized manner. Presenting available drivers 37 in a prioritized manner may mean that any particular driver 37 may be ranked, tiered, or the like. The passenger 38 may be able to sort the available drivers 37 based on criteria, including, but not limited to, acceptable driver fee, current proximity to passenger, seating capacity, vehicle characteristics, or the like. The present invention contemplates that the user interface may change based on certain criteria being selected by either the passenger or the driver. For example, a passenger may input that a desired vehicle size must be able to hold a number of passengers as well as luggage, and upon including the desired vehicle size, the user interface may be adjusted to only show those vehicles that are suitable for the passenger's needs.

The dispatch system 36 may have a selection module 49 to allow the passenger to select an available driver 37. Once an available driver 37 is selected, the dispatch system 36 may utilize a notice module 50 to provide a message to the available driver 37, who was selected by the passenger 38, and who will be providing services to the passenger 38. The message may include information related to the passenger 38. The additional information may include, but is not limited to, information related to the passenger's location, passenger's name, passenger's physical appearance, passenger's desired destination, or the like. The notice module 50 may provide additional information to the passenger 38 about the driver 37 after the passenger 38 has selected the available driver 37. Such information may include, but is not limited to, vehicle make, model, color, driver's name, driver's physical appearance, or the like. The dispatch system 36 may also provide the passenger 38 and driver 37 with information related to the costs of the driver's services. The driver 37 and the passenger 38 may have an opportunity to confirm or verify that what they will provide and receive services from each other.

The fee module 43 may utilize the acceptable driver fee 32 provided by the driver 37 and the acceptable passenger fee 34 provided by the passenger 38 to determine the actual fee charged to the passenger 38. The actual fee may be the lowest acceptable driver fee 32 set by the driver 37. The actual fee may be the highest acceptable passenger fee 34 set by the passenger 38. The actual fee may be between the lowest acceptable driver fee 32 and the highest acceptable passenger fee 34. By way of example, and not as a limitation, the actual fee may be the midpoint between the lowest acceptable driver fee 32 and the highest acceptable passenger fee 34. On providing an acceptable driver fee 32, the driver 37 may agree to enter into a contractual obligation to provide services to the passenger 38 selecting an acceptable passenger fee 34 at least as high as the acceptable driver fee 32. Upon providing an acceptable passenger fee 34, the passenger 38 may agree to enter into a contractual obligation to pay for services provided by a driver 37 selecting an acceptable driver fee 32 at least as low as the acceptable passenger fee 34.

Users of the dispatch system 36 may agree to pay an administrative fee to an administrator in exchange for using the dispatch system 36. The administrative fee may be deducted from the acceptable driver fee 32, may be added to the acceptable passenger fee 34, may be in addition to the acceptable passenger fee 34 or acceptable driver fee 32, or may be any combination of these. The administrative fee may be calculated as a percentage of the fees agreed to by the passenger 38 and driver 37. The administrative fee may be calculated as the difference between the highest price the passenger 38 is willing to pay and the lowest price the driver 37 is willing to accept.

Payment may be made to the driver 37 through the dispatch system 36. The passenger 38 may provide payment information to the dispatch system 36. The dispatch system 36 may collect payment from the passenger 38. Fees charged by the dispatch system 36 may be deducted from payments received from passengers 38. Fees due to the driver 37 may be delivered to the driver 37 through the dispatch system. These payments may be made to the driver 37 in batches or at the conclusion of each transaction. The driver 37 may receive individual payments from the dispatch system 36 for each ride provided by the driver 37. The driver 37 may receive a single payment from the dispatch system 36 for multiple rides provided by the driver 37,

The dispatch system 36 may also provide an insurance verification module 51 that implements a method for ensuring the passenger 38 and the vehicle are covered by an insurance policy. The driver 37 may purchase vehicle insurance. The owner or operator of the vehicle may purchase vehicle insurance. The vehicle insurance may automatically cover the vehicle when the vehicle is being actively used as a for-hire vehicle. The dispatch system 36 may require that such vehicle insurance be purchased. Use of the dispatch system 36 by the driver 37 may be consent to purchase and pay for vehicle insurance on behalf of the driver 37. The dispatch system 36 may prevent use of the graphical interface 30 in the absence of proof of such vehicle insurance.

In addition to vehicle insurance, passenger insurance may be required. Passenger insurance may protect the passenger 38 while the passenger 38 is utilizing the vehicle. Passenger 38 insurance may be purchased by the passenger 38, the driver, the vehicle operator, vehicle owner, or the like. The passenger insurance may only provide coverage when a passenger 38 is in the vehicle. The system may require that such passenger insurance be purchased. Use of the graphical interface 30 provided by the dispatch system 36 by the driver 37 may be consent to purchase and pay for passenger insurance. Use of the graphical interface 30 provided by the dispatch system 36, by the passenger 38 may be consent to purchase and pay for passenger insurance. The dispatch system 36 may prevent use of the graphical interface 30 in the absence of proof of such passenger insurance.

Both the driver 37 and the passenger 38 may be covered by insurance upon acceptance of a fare. That is, from the moment the driver 37 agrees to provide a ride to the passenger 38, the driver 37 may be covered by insurance. Additionally, from the moment the passenger 38 agrees to accept a ride from the driver 37, the driver 37 may be covered by insurance. Additional insurance protecting the passenger 38 may activate when the passenger 38 enters the vehicle. Such insurance protection may be referred to as no fault livery/rideshare passenger trip insurance.

The passenger 38 and driver 37 may access the dispatch system 36 utilizing an application running on a mobile device. This application to verify insurance may be the same or in addition to the application used by the passenger 38 and driver 37 to be paired with a driver 37 and passenger 38, respectively. The dispatch system 36 may automatically provide an indication to the passenger 38 whether or not the passenger 38 would be protected by an insurance policy when utilizing the services of the vehicle driver 37. The indication may be provided to the passenger 38 based on insurance information stored in a database along with location information provided to the application by a GPS sensor in a passenger's 38 mobile device. The application may also utilize location information provided to the application by a GPS sensor in a vehicle to determine if the passenger 38 may be protected by an insurance policy when utilizing one or more vehicles proximate the passenger 38.

The map module 47 may utilize information received from GPS sensors. The GPS sensors associated with the driver 37 may be integrated into the vehicle, may be integrated into a mobile device used by the driver, or the like. The GPS sensors associated with the passenger 38 may be integrated into a passenger's noble device.

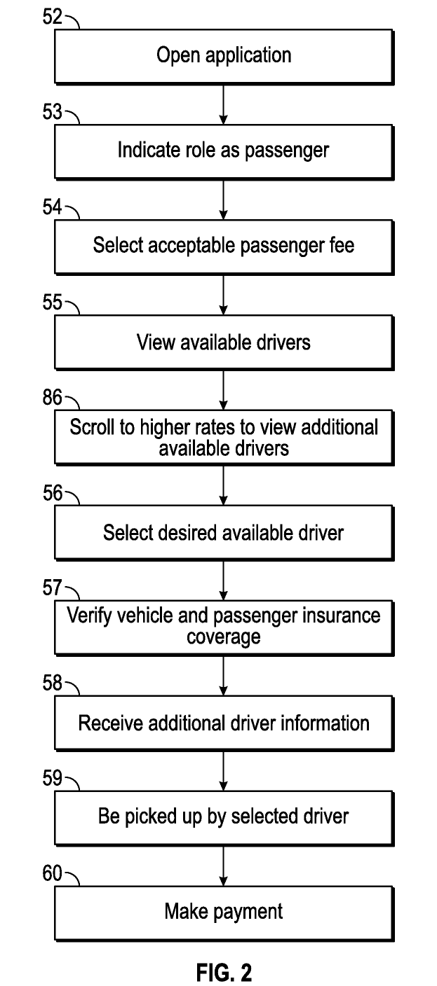

Turning to FIG. 2, an embodiment of the inventive method utilized by a passenger 38 is shown. Utilizing the dispatch system 36 and associated methods, the passenger 38 may open the application providing a graphical interface to the dispatch system 52. The passenger may indicate to the dispatch system 36 the passenger's role as a passenger 53. The passenger may utilize the graphical interface to select an acceptable passenger fee that the passenger is willing to pay for services provided by the driver 54. The passenger may view available drivers presented by the graphical interface 55. The passenger may optionally scroll to higher rated to view additional available drivers 86. The driver may interact with the graphical interface to select the desired available driver 56. The dispatch system may verify that the selected driver has vehicle and passenger insurance coverage 57. The passenger may receive additional information related to the selected driver 58. The passenger may be picked up by the selected driver 59. The passenger may make payment for the services received from the driver 60.

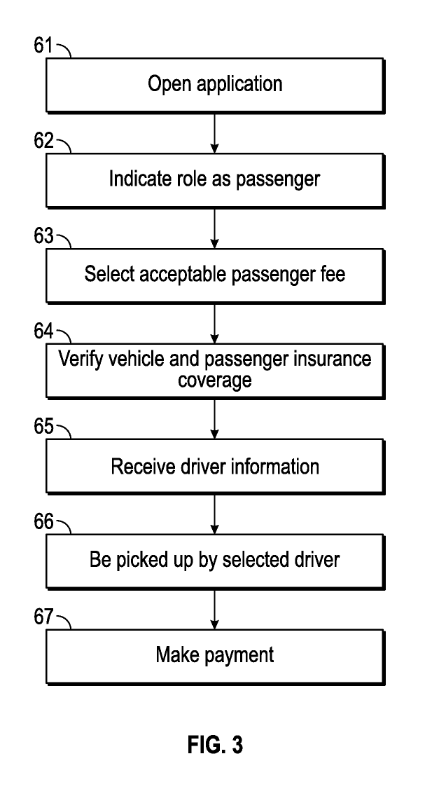

Turning to FIG. 3, an embodiment of the inventive method utilized by a passenger 38 is shown. Utilizing the dispatch system 36 and associated methods, the passenger 38 may open the application providing a graphical interface to the dispatch system 61. The passenger may indicate to the dispatch system 36 the passenger's role as a passenger 62. The passenger may utilize the graphical interface to select an acceptable passenger fee that the passenger is willing to pay for services provided by the driver 63. A driver utilizing the dispatch system may select the passenger as the driver's fare. The dispatch system may verify that the driver who has selected the passenger has vehicle and passenger insurance coverage 64. The passenger may receive information related to the selected driver 65. The passenger may be picked up by the driver 66. The passenger may make payment for the services received from the driver 67.

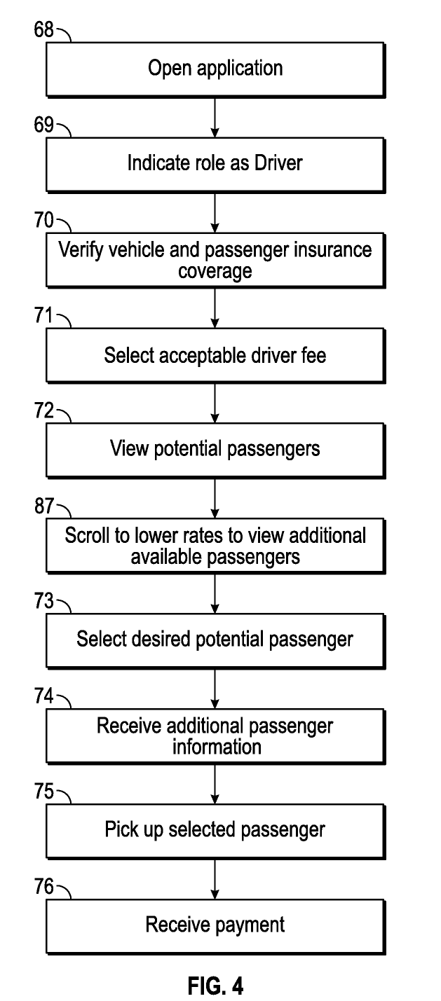

Turning to FIG. 4, an embodiment of the inventive method utilized by a driver 37 is shown. Utilizing the dispatch system 36 and associated methods, the driver 37 may open the application providing a graphical interface to the dispatch system 68. The driver may indicate to the dispatch system 36 the driver's role as a driver 69. The dispatch system may verify that the driver using the dispatch system has vehicle and passenger insurance coverage 70. The driver may utilize the graphical interface to select an acceptable driver fee that the driver is willing to receive for services provided to the passenger 71. The driver may view potential passengers presented by the graphical interface 72. The driver may optionally scroll to lower rates to view additional available passengers 87. The driver may interact with the graphical interface to select the desired potential passenger 73. The driver may receive additional information related to the selected passenger 74. The driver may pick up the selected passenger 75. The driver may receive payment for the services provided to the passenger 76.

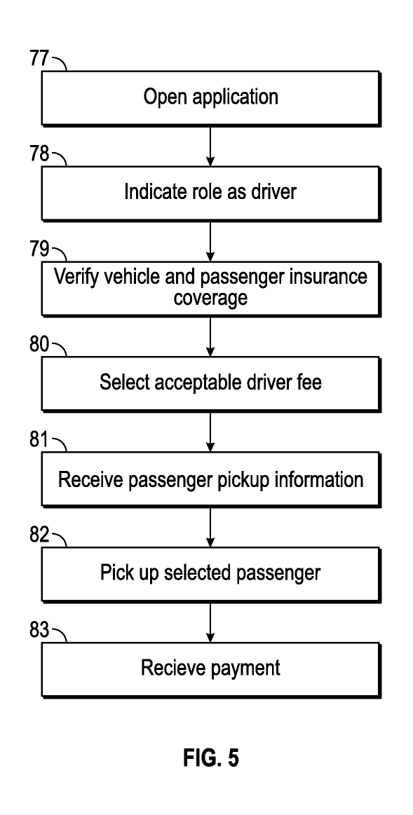

Turning to FIG. 5, an embodiment of the inventive method utilized by a driver 37 is shown. Utilizing the dispatch system 36 and associated methods, the driver 37 may open the application providing a graphical interface to the dispatch system 77. The driver may indicate to the dispatch system 36 the driver's role as a driver 78. The dispatch system may verify that the driver using the dispatch system has vehicle and passenger insurance coverage 79. The driver may utilize the graphical interface to select an acceptable driver fee that the driver is willing to receive for services provided to the passenger 80. A passenger utilizing the dispatch system may select the driver to provide services. The driver may receive information related to the passenger 81. The driver may pick up the passenger 82. The driver may receive payment for the services provided to the passenger 83.

An important feature of the dispatch system 36 is the ability for both passenger 38 and driver 37 to select the fees they are willing to pay and receive, respectively.

An exemplary use of the dispatch system 36 may be provided by an executive running late for an important meeting. By way of example, and not as a limitation, in this example, the executive is the passenger 38. The passenger 38 needs to travel four miles quickly. He opens the graphical interface 30 and sets the acceptable passenger fee 34 to a maximum amount. This results in the immediate display of every available driver 37 utilizing the dispatch system 36. He may then select the closest driver 37 or the driver 37 who is positioned to pick him up most quickly. The executive passenger 38 in this example indicated a willingness to pay a premium price in order to receive fast service.

Another exemplary use of the dispatch system 36 may be provided by an impoverished individual requiring transportation to care for a sick relative, By way of example, and not as a limitation, in this example, the impoverished individual is the passenger 38. The passenger 38 needs to travel 9 miles but is in no hurry to reach his destination. The passenger 38 may open the graphical interface 30 and set the acceptable passenger fee 34 to a minimum amount. This results in the graphical interface 30 displaying no available drivers 37. The dispatch system 36 may periodically check for drivers 37 willing to accept the minimum amount. Eventually, a driver 37 willing to accept the minimum amount may be displayed to passenger 38. The impoverished passenger 38 in this example indicated a willingness to wait to receive an affordable rate.

Yet another exemplary use of the dispatch system 36 may be provided by an entrepreneurial driver 37. By way of example, and not as a limitation, the driver 37 may set his acceptable driver fee 32 slightly under the city ordinance mandated rate in hopes of acquiring extra fares by slightly underbidding other services. Provided no desirable passengers 38 are displayed by the graphical interface 30 at the acceptable driver fee 32 set by the driver 37, the driver 37 may scroll to a lower acceptable driver fee 32. The selection of the lower acceptable driver fee 32 may result in the display of passengers 38. The driver 37 may decide that the displayed passengers 38 are too far away to pick up. The driver 37 may scroll to a still lower acceptable driver fee 32 until a passenger 38 in a desired location in displayed,

A final exemplary use of the dispatch system 36 may be provided by an airport driver 37. By way of example, and not as a limitation, the driver 37 may increase his acceptable driver fee 32 upon realizing that a plane has recently arrived and there are an insufficient number of drivers 37 present at the airport to transport the newly arrived passengers 38,

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

That which is claimed is:

1. A dispatch system comprising:
a driver scale displayed on a driver graphical interface;
an acceptable driver fee associated with a portion of the driver scale, selectable by a driver, and displayed on the driver graphical interface; and
passenger indicia displayed on the driver graphical interface dependent on the value of the selected acceptable driver fee.

2. The dispatch system according to claim 1 further comprising:
a passenger scale displayed on a passenger graphical interface;
an acceptable passenger fee associated with a portion of the passenger scale, selectable by a passenger, and displayed on the passenger graphical interface: and
driver indicia displayed on the passenger graphical interface dependent on the value of the selected acceptable passenger fee and the selected acceptable driver fee.

3. The dispatch system according to claim 2 wherein the display of the passenger indicia is further dependent on the value of the selected acceptable passenger fee.

4. The dispatch system according to claim 1 further comprising a map;
wherein each of the passenger indicia is associated with a respective passenger; and
wherein the passenger indicia are displayed at locations on the map corresponding to geographic locations of the respective passengers associated with each of the passenger indicia.

5. The dispatch system according to claim 2 further comprising a map;
wherein each of the driver indicia is associated with a respective driver; and
wherein the driver indicia are displayed at locations on the map corresponding to geographic locations of the respective drivers associated with each of the driver indicia,

6. The dispatch system according to claim 1 wherein the display of passenger indicia on the driver graphical interface is further dependent on the value of prioritization criteria.

7. The dispatch system according to claim 2 wherein the passenger indicia is selectable by the driver;
wherein each of the passenger indicia is associated with a respective passenger; and
wherein a message is sent to the associated respective passenger upon selection of the passenger indicia.

8. A dispatch system comprising:
a graphical display module adapted to provide a graphical interface to a user;
a fee module comprising:
a driver scale module adapted to provide a driver scale to the graphical display module, and
a passenger scale module adapted to provide a passenger scale to the graphical display module;
wherein the driver scale or passenger scale is displayed on the graphical interface.

9. The dispatch system according to claim 8 wherein the fee module calculates an administrative fee as the difference between an acceptable passenger fee selected from the passenger scale by a passenger and an acceptable driver fee selected from the driver scale by a driver.

10. The dispatch system according to claim 8 further comprising:
a user role determination module adapted to provide a user role to the fee module,

11. The dispatch system according to claim 8 wherein the graphical display module further comprises:
a map module adapted to display a map on the graphical interface with the passenger indicia displayed at locations corresponding to the geographical locations of passengers associated with respective passenger indicia.

12. The dispatch system according to claim 11 further comprising:
a priority module adapted to manipulate the appearance of the passenger indicia dependent on the value of prioritization criteria.

13. The dispatch system according to claim Error! Reference source not found. further comprising:
a priority module adapted to manipulate the appearance of the driver indicia dependent on the value of prioritization criteria.

14. The dispatch system according to claim 11 further comprising:
a selection module adapted to receive input from a driver indicating the passenger indicia selected by the driver.

15. The dispatch system according to claim 14 further comprising:
a notice module adapted to provide a message to the passenger associated with the selected passenger indicia.

16. The dispatch system according to claim Error! Reference source not found. further comprising:
a selection module adapted to receive input from a passenger indicating the driver indicia selected by the passenger.

17. The dispatch system according to claim 16 further comprising:
a notice module adapted to provide a message to the driver associated with the selected driver indicia.

18. The dispatch system according to claim 8 further comprising:
an insurance verification module comprising:
a passenger insurance verification module adapted to provide passenger insurance coverage information to the graphical display module, and
a driver insurance verification module adapted to provide driver insurance coverage information to the graphical display module.

19. A dispatch system comprising:
a graphical display module adapted to provide a graphical interface to a user;
a fee module comprising:
a driver scale module adapted to provide a driver scale to the graphical display module, and
a passenger scale module adapted to provide a passenger scale to the graphical display module;
a user role determination module adapted to provide a user role to the fee module;
a map module adapted to display a map on the graphical interface with passenger indicia displayed at locations corresponding to the geographical locations of passengers associated with respective passenger indicia when the user role is defined as driver and adapted to display driver indicia displayed at locations corresponding to the geographical locations of drivers associated with respective driver indicia when the user role is defined as passenger;
a selection module adapted to receive input a user indicating the passenger indicia or driver indicia selected by the user;
an insurance verification module comprising:
a passenger insurance verification module adapted to provide passenger insurance coverage information to the graphical display module, and
a driver insurance verification module adapted to provide driver insurance coverage information to the graphical display module.
wherein the driver scale or passenger scale are displayed on the graphical interface; and
wherein the fee module calculates an administrative fee as the difference between an acceptable passenger fee selected from the passenger scale by a passenger and an acceptable driver fee selected from the driver scale by a driver,

20. The dispatch system according to claim 19 further comprising:
a priority module adapted to manipulate the appearance of the passenger indicia when the user role is defined as driver and the appearance of the driver indicia when the user role is defined as passenger, the manipulation dependent on the value of prioritization criteria.
